(19) United States
(12) Patent Application Publication
(10) Pub. No.: US 2002/0033120 A1
(43) Pub. Date: Mar. 21, 2002

(54) Method of making cement from tailings or rock fines containing silicate or siliceous compounds

(76) Inventors: Roberto Berardi, Sudbury (CA); David Krofchak, Copper Cliff (CA)

Correspondence Address: GOWLING LAFLEUR HENDERSON LLP, P.O. Box 1045 LCD1, 120 King Street West, Suite 560, Hamilton, ON, L8N 3R4, CA

(21) Appl. No.: 09/892,488

(22) Filed: Jun. 28, 2001

Related U.S. Application Data
(63) Continuation-in-part of application No. 09/580,347, filed on May 25, 2000.
(60) Provisional application No. 60/137,403, filed on Jun. 1, 1999.

(51) Int. Cl. C04B 7/24; C04B 14/04

(52) U.S. Cl. 106/738; 106/745

(57) ABSTRACT

A method of making cement from tailings or rock fines containing silicate or siliceous compounds includes grinding the tailings or rock fines to a size in the range of from about −250 to about 425 mesh to produce ground pozzolan. The ground pozzolan is mixed with Type 1 normal Portland cement or Type 3 high early strength Portland cement in a ratio of at least about 0.1:1 by weight to produce a blended cement.

### RELATED APPLICATIONS

This application is a continuation in part of U.S. patent application Ser. No. 09/580,347 filed May 25, 2000 which claims priority from U.S. Provisional Patent Application No. 60/137403 filed Jun. 1, 1999.

### FIELD OF INVENTION

This invention relates to a method of making cement from tailings or rock fines containing silicate or siliceous compounds and also for recovering metals from the tailings.

### BACKGROUND OF INVENTION

The use of supplementary cementing materials has gained wide acceptance in the construction industry since 1986. In general, supplementary cementing materials comprise natural pozzolans, fly, ash, ground granulated blast furnace slag and silica fume and they are added at the mixing plant to supplement the Portland cement in concrete. Also, base metal (copper, nickel, lead or zinc) smelter slag can be used to produce a slag cement for use in making concrete in the manner described and claimed in U.S. Pat. No. 5,593,493 and 5,749,962 (Krofchak).

A natural pozzolan is a volcanic ash containing siliceous compounds. The Romans used to add burnt lime thereto to form cementitious compounds. Buildings built using such compounds still exists.

In modern times, other synthetic pozzolanic materials have been used, such as power station fly ash and silica fume from furnace operations. These materials have become so useful as supplemental additives to Portland cement that they are very sought after. Another such material is granulated blast furnace slag, CaO SiO₂, which is superior to most other pozzolanic materials.

As a result of the success of these materials, demand has created a search for further such materials. Consequently, any material having sufficient lime, alumina and silica content would be a target material for a pozzolanic supplementary material.

It has recently been realized that mine tailings have sufficient values of lime, alumina and silica, and might be a candidate as pozzolanic material. It would therefore be necessary to find a way in which mine tailings can be processed into a satisfactory pozzolanic material. If this can be accomplished, it would provide a major economic solution to dealing with mine tailings, while at the same time create a prolific source of a pozzolanic material for the cement industry.

Mine tailings or, to be more specific, mill tailings are produced by the beneficiation of ores to yield a high purity mineral for further refining. Mill tailings consist mainly of finely divided waste rock (generally siliceous compounds), usually with trace quantities of the mineral being recovered, which is too poor to be treated further, or with minerals which are uneconomical to recover. There is a danger that such minerals may have the potential of being reduced or oxidized to more hazardous materials in their finely divided state when exposed to elements in a surface disposal area.

The usual disposal of mill tailing comprises dumping them in slurry form into a disposal area of sufficient area to ensure that decanted water is free of suspended solids. Over the last forty years, more and more severe restrictions on discharges from tailing disposal areas have been enacted. From essentially no restrictions, other than keeping the gangue on mine property, it is now necessary to provide an accounting of metals leaching from the tailings in parts per billion and, in some cases, in parts per million. Also, it is now sometimes required that mine/mill operations carry out water treatment on tailing discharges to meet current criteria. Of course, the above is true only of the most environmentally conscious countries, but the trend is apparent on a worldwide basis.

No one, so far as is known, has yet found a solution to the problems of the tailing ponds, and the fact that it has been found that they are leaching heavy metal values has caused mining companies to seek acceptable solutions to this growing problem. Also, environmental authorities are requiring plans to be formulated for long-term permanent solutions.

It has now also been realized that quarry rock fines have sufficient values of lime, alumina and silica, and might be a candidate as pozzolanic material. It would therefore be necessary to find a way in which rock fines can be processed into a satisfactory pozzolanic material. If this can be accomplished, it would provide a major economic solution to dealing with waste quarry fine materials, while, at the same time, create a prolific source of a pozzolanic material for the cement industry.

Aggregates and stones for general concrete products and other purposes such as railroad ballast or road support are provided by crushing rock from quarries. The crushing from the host materials ends up producing as by-products fine materials (¼″ down) that have limited uses and end up being piled beside the quarries as waste.

It is therefore an object of this invention to provide a method of using tailings or rock fines containing silicate or siliceous compounds to produce pozzolans suitable for manufacturing predictable grades of low, medium and high strength concrete for general construction purposes, including mine backfill and shotcrete, and to recover metal values from the tailings which would otherwise be lost.

### SUMMARY OF INVENTION

According to the invention, a method of making cement from tailings or rock fines containing siliceous compounds comprises grinding the tailings to a size within the range of from about −250 to about 425 mesh to produce ground pozzolan, and mixing the ground pozzolan with Type 1 normal Portland cement or Type 3 high early strength Portland cement in a ratio of at least about 0.1:1 by weight to produce a blended cement.

The ground pozzolan may be mixed with the Portland cement in the range of from about 0.1:1 to about 1.75:1. The ground pozzolan may also be mixed with the Portland cement in a ratio of up to about 2.5:1 to dispose of extra tailings or rock fines without unduly reducing compressive strength, i.e. without reducing compressive strength below acceptable standards.

The tailings or rock fines may contain from about 15% to about 95% SᵢO₂, from about 0 to about 35% Al₂0₃ and from about 0 to about 35% CaO by weight.

Appropriate amounts of sand and stone can be added in the presence of moisture to produce low, medium or high strength concrete as required. The ground pozzolan chemically reacts with calcium hydroxide released by the hydration of Portland cement to form compounds possessing cementing properties.

Metal values in ground tailing pozzolan can be separated by magnetic or gravitational separation or by other techniques known to those skilled in the art.

Such utilization of tailings to produce a pozzolan substantially completely solves the environmental disposal problem of tailings in ponds and eliminates the risk of heavy metals leaching, while at the same time providing a viable and practical use for the tailings. Such utilization of rock fines to produce a pozzolan substantially completely solves the problem of rock fines piles, while at the same time providing a viable and practical use therefor.

Various examples of methods carried out in accordance with the present invention will now be described.

### EXAMPLE 1

A composite sample of tailings was obtained from tailing ponds which have been accumulated for over 50 years from one of the world's largest nickel producers located in Sudbury, Ontario, Canada.

The sample was ground to −325 mesh to produce ground tailing pozzolan and was analyzed as follows: (by weight)

| | | | | | |
|---|---|---|---|---|---|
| SiO2 | 49.89% | TiO2 | 0.96% | Sr (ppm) | 166 |
| Al2O3 | 12.05% | MnO | 0.17% | Zr (ppm) | 176 |
| Fe2O3 | 18.52% | P2O5 | 0.16% | Co (ppm) | 61 |
| CaO | 6.21% | S | 3.24% | Cr (ppm) | 486 |
| MgO | 5.90% | Pyrrhotite | 7.14% | Cu (ppm) | 459 |
| Na2O | 1.74% | C | 0.09% | Ni (ppm) | 1022 |
| K2O | 1.17% | Ba (ppm) | 348 | Zn (ppm) | 245 |

The ground tailing pozzolan was subjected to magnetic separation, and the pyrrhotite, which contained virtually all the metals, was recovered. The analysis of the pyrrhotite was as follows:

| | | | | | |
|---|---|---|---|---|---|
| SiO2 | 4.96% | TiO2 | 0.64% | Sr (ppm) | 191 |
| Al2O3 | 1.25% | MnO | 0.05% | Zr (ppm) | 428 |
| Fe2O3 | 77.01% | P2O5 | 0.02% | Co (ppm) | 461 |
| CaO | 0.74% | Fe | 53.9% | Cr (ppm) | 489 |
| MgO | 0.83% | S | 25.1% | Cu (ppm) | 859 |
| Na2O | 0.19% | Ba (ppm) | 537 | Ni (ppm) | 7000 |
| K2O | 0.16% | | | Zn (ppm) | 570 |

The analysis of the ground tailing pozzolan after pyrrhotite removal was as follows:

| | | | | | |
|---|---|---|---|---|---|
| SiO2 | 53.3% | TiO2 | 0.98% | Sr (ppm) | 0.003 |
| Al2O3 | 12.89% | MnO | 0.16% | Zr (ppm) | 0.003 |
| Fe2O3 | 14.42% | P205 | 0.14% | Co (ppm) | 0.001 |
| CaO | 6.64% | S | 1.68% | Cr (ppm) | 0.009 |
| MgO | 6.36% | Pyrrhotite | <0.002% | Cu (ppm) | 0.091 |
| Na2O | 1.87% | C | 0.08% | Ni (ppm) | 0.02 |
| K2O | 1.25% | Ba (ppm) | 0.006 | Zn (ppm) | 0.049 |

The ground tailing pozzolan, free of metals, was then blended with Type 1 normal Portland cement in different proportions and 2″ concrete cubes were made in accordance with the American Society for Testing Materials (ASTM). The cubes were then tested for compressive strength at 3, 7 and 28 days and compared with the ASTM Minimum Requirements (Min. Req.).

Compressive Strength Test

| | | | | | Compressive | | |
|---|---|---|---|---|---|---|---|
| | Mix Proportion in gm | | | | Strength in psi | | |
| | Cement | Sand | Tailings | Water | 3 day | 7 day | 28 day |
| Min. Req. | 500 | 1375 | — | 242.5 | 2103 | 2900 | 3843 |
| #1 | 250 | 1375 | 250 | 242.5 | 2132 | 2958 | 4083 |
| #2 | 325 | 1375 | 175 | 242.5 | 2389 | 3630 | 4701 |
| #3 | 425 | 1375 | 75 | 242.5 | 2623 | 3927 | 5436 |

From these results, it is clear that the cubes made with the blend of the ground tailing pozzolan and Portland cement exceeded the ASTM requirements for use in concrete and mortars.

The Pozzolanic Strength Activity Index (P.S.A.I.) at 28 days has to be at least 75% of that of a control sample. The P.S.A.I. with Portland cement according to the ASTM Standards is calculated in the following manner:

Pozzolanic Strength Activity Index with Portland cement=(A/B)×100

Where: A=average compressive strength of test mix cubes made with 80% Portland cement and 20% by weight of the tailing cement (6163 psi) B=average compressive strength of control mix cubes (5075 psi)

For the tailing cement, the P.S.A.I.=6163/5075×100=121.4%, which is of course significantly higher than 75%.

### EXAMPLE 2

In this example, Type 3 high early strength Portland cement was used instead of Type 1 normal Portland cement in order to obtain high strength concrete. The results are as follows:

Compressive Strength Test

| | | | | | Compressive | | |
|---|---|---|---|---|---|---|---|
| | Mix Proportion in gm | | | | Strength in psi | | |
| | Cement | Sand | Tailings | Water | 3 day | 7 day | 28 day |
| Min. Req. | 500 | 1375 | — | 242.5 | 2103 | 2900 | 3843 |
| #1 | 250 | 1375 | 250 | 242.5 | 267 | 217 | 4365 |
| #2 | 325 | 1375 | 175 | 242.5 | 384 | 637 | 5528 |
| #3 | 425 | 1375 | 75 | 242.5 | 502 | 867 | 7042 |

Again, the results significantly exceed the ASTM requirements and show that this invention is technically very successful.

### EXAMPLE 3

Various leach tests were carried out with broken pieces of the 2″ cubes after compressive strength testing. The results are as follows:

### Leach Test

Tailings were leached in water/acid in accordance with the Environment Protection Agency (EPA) test standards, and the results were compared to those from the crushed cubes:

| Metal | Crushed cubes | Tailings | Regulations to Water Course |
|---|---|---|---|
| Fe | 0.006 mg/l | 160.3 mg/l | 1.0 mg/l |
| Cu | 0.043 mg/l | 46.02 mg/l | 0.3 mg/l |
| Ni | 0.011 mg/l | 39.01 mg/l | 0.3 mg/l |
| Co | 0.004 mg/l | 0.97 mg/l | 0.3 mg/l |

The tailings as they are in the lagoons showed a high leachability, while the crushed cubes made with tailing pozzolan and Portland cement leached metals safely below currently regulated limits.

### EXAMPLE 4

A series of 300 freeze/thaw cycles were carried out on six 2″ cubes having the composition of Examples 1 and 2 in order to assess their durability to resist to exposure conditions which are the most destructive factors causing deterioration of concrete. The cubes were placed in a freezer 12 hours later, i.e. thawed in water during the day and frozen in the freezer over night. After the cycles, no deterioration was visible in the form of cracking, sealing, or crumbling of the surfaces, thus demonstrating that tailing pozzolan produced concrete with good durability.

### EXAMPLE 5

Concrete hollow blocks were made using tailing pozzolan and Type 3 high early strength Portland cement and compared with a control made with straight Type 3 high early strength Portland cement.

The results were as follows:

| | Mix Proportion in Kg | | | | | Compressive | | | |
|---|---|---|---|---|---|---|---|---|---|
| | | Tailing | | Lime- | | Strength in psi | | | |
| | Cement | Pozzolan | Sand | stone | Water | 1 day | 7 day | 14 day | 28 day |
| Control | 210 | — | 1690 | 1125 | 50 liters | 2247 | 2451 | 2573 | 2757 |
| #1 | 178 | 32 | 1690 | 1125 | 50 liters | 2231 | 2400 | 2563 | 2691 |
| #2 | 157 | 53 | 1690 | 1125 | 50 liters | 2159 | 2398 | 2412 | 2585 |

As can be seen, the concrete blocks made with a blend of tailing pozzolan and Type 3 Portland cement show comparable strength to the control.

### EXAMPLE 6

Cylinders (411″×811″) were made for testing tailing pozzolan in mine backfill, with the following results:

| | Mix Proportion in g | | | | | | | |
|---|---|---|---|---|---|---|---|---|
| | Type 1 | Blast | | | | Compressive | | |
| | Portland | Furnace | Tailing | Tailings | | Strength in psi | | |
| | Cement | Slag | Pozzolan | Coarse | Water | 3 day | 7 day | 28 day |
| Control 1 | 167 | 1500 | — | 25000 | 11000 | 14 | 34 | 75 |
| #1 | 133 | 1201 | 333 | 25000 | 11000 | 18 | 38 | 77 |

The water content in the tailing was 32% in order to enable it to be pumped back to the mine without plugging the pipes, and the cement/tailing ratio was 1:15.

| | Mix Proporation in g | | | | | | | |
|---|---|---|---|---|---|---|---|---|
| | Type 1 | Blast | | | | Compressive | | |
| | Portland | Furnace | Tailing | Tailings | | Strength in psi | | |
| | Cement | Slag | Pozzolan | Coarse | Water | 3 day | 7 day | 28 day |
| Control 2 | 86 | 778 | — | 25920 | 11080 | 14 | 28 | 43 |
| #2 | 69 | 622 | 173 | 25920 | 11080 | 18 | 30 | 45 |

The water content in the tailing was 28%, in order to enable it to be pumped to the mine without plugging the pipes, and the cement/tailing ratio was 1:30.

As can be seen, the strength results with tailing pozzolan are very satisfactory.

### EXAMPLE 7

Various examples of rock fines from different quarries in Northern Ontario, Canada were obtained.

The samples were ground to −325 mesh and were analyzed as follows: (by weight)

| | | | |
|---|---|---|---|
| SiO2 | 40-80% | K2O | 0.5-1.5% |
| Al2O3 | 5-25% | TiO2 | 0.2-2.9% |
| Fe2O3 | 5-20% | MnO | 0.1-0.3% |
| CaO | 0-25% | P2O5 | 0.02-0.9% |
| MgO | 4-12% | S | 0.05-1.1% |
| Na2O | 1-2% | CO2 | 0.01-2.5% |

The ground rock pozzolan was then blended with Type 1 normal Portland cement and concrete prestressed slabs and pipes were made to be compared to those ones with straight Type 1 normal Portland cement.

The results were as follows:

| | Mix Proportion in Kg | | | | | Compressive | |
|---|---|---|---|---|---|---|---|
| Prestressed | | Rock | | | | Strength in psi | |
| Slabs | Cement | Pozzolan | Sand | Aggregates | Water | 1 day | 28 day |
| Control | 395 | — | 394 | 1184 | 250 | 6815 | 9937 |
| #1 | 316 | 79 | 394 | 1184 | 250 | 6474 | 9895 |
| | Mix Proportion in Kg | | | | | Compressive | |
| | | Rock | | | | Strength in psi | |
| Pipes | Cement | Pozzolan | Sand | Aggregates | Water | 1 day | 28 day |
| Control | 198 | — | 195 | 590 | 120 | 3625 | 7395 |
| #1 | 158 | 40 | 195 | 590 | 120 | 3590 | 7302 |

Again the strength results between the control and the test with rock pozzolan are highly comparable.

Numerous other tests have been conducted using varying amounts of Type 1 normal Portland cement, Type 3 high early strength Portland cement, sand and different type of tailings containing siliceous compounds. Various chemical additives were also used to implement the pozzolanic properties of the tailings. All have produced satisfactory results, but more particularly, the method according to this invention has advantageously made use of the tailings to make various grades of concrete, while simultaneously solving a growing and perplexing environmental problem.

Thus, an economical and viable solution has been invented for the disposal or recycling of a waste material into a valuable raw product from which important and increasingly useful products can be made, namely concrete, shotcrete and cement for mine backfill. At the same time, the metals lost in the tailings can be recovered, thus eliminating any risk of leaching.

Other examples of the invention will be readily apparent to a person skilled in the art from the foregoing description.

1. A method of making cement from tailings or rock fines containing silicate or siliceous compounds comprising grinding the tailings or rock fines to a size in the range of from about −250 to about 425 mesh to produce ground pozzolan, and mixing the ground pozzolan with Type 1 normal Portland cement or Type 3 high early strength Portland cement in a ratio of at least about 0.1:1 by weight to produce a blended cement.

2. A method according to claim 1 wherein the ground pozzolan is mixed with the Portland cement in a ratio in the range of from about 0.1:1 to about 1.75:1.

3. A method according to claim 1 wherein the ground pozzolan is mixed with the Portland cement in a ratio of up to about 2.5:1 to dispose of extra tailings or rock fines without unduly reducing compressive strength.

4. A method according to claim 1 wherein the tailings rock fines contain from about 15% to about 95% SᵢO_{2,} from about 0 to about 35% Al₂O₃ and from about 0 to about 35% CaO by weight.

5. A method according to claim 1 wherein sand, stone and water are added to the blended cement to produce concrete.

6. A method according to claim 1 including separating metal values from ground tailing pozzolan before mixing with the Portland cement.
